(19) United States
(12) Patent Application Publication
(10) Pub. No.: US 2004/0057087 A1
(43) Pub. Date: Mar. 25, 2004

(54) Image reading device and image forming apparatus

(76) Inventor: Shinichiroh Wada, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/653,887

(22) Filed: Sep. 4, 2003

(30) Foreign Application Priority Data
Sep. 5, 2002 (JP) 2002-260232

(51) Int. Cl. H04N 1/04

(52) U.S. Cl. 358/497; 358/474

(57) ABSTRACT

An image reading device comprises a photoelectric conversion unit converting image data, optically read from a document, into an analog signal. A reading optical unit irradiates light to the document and directs a reflected light from the document to the photoelectric conversion unit. An analog-signal processing unit samples the analog signal and performs gain adjustment of the sampled analog signal in response to a control signal. An analog-to-digital conversion unit converts the analog signal, outputted by the analog-signal processing unit, based on a reference voltage to output a digital signal of the read data at an output level. A correction unit optimizes the output level of the read data signal for each of a first reading mode and a second reading mode by changing either the control signal to the analog-signal processing unit or the reference voltage to the analog-to-digital conversion unit.

### BACKGROUND OF THE INVENTION

1. Field of the Invention

The present invention generally relates to an image reading device, and more particularly to an image reading device using a sheet-through document feeder, as well as an image forming apparatus including the image reading device.

2. Description of the Related Art

Concerning the digital multi-function peripheral (MFP) which is equipped with at least two functions among image forming functions, including the copier function, the printer function and the fax function, the number of MFP models which incorporate the sheet-through document feeder (SDF) or the automatic document feeder is increasing. Also, the number of MFP models in which the SDF is used to carry out the image reading of a document set on the document plate at the time of performing the copier function or the fax function is increasing.

In the conventional image reading devices of this kind, not only the contact glass for setting the document fixedly thereon but also the SDF contact glass for setting the document delivered by the SDF is arranged. When the SDF is used for image reading, the scanner unit, which is provided to optically read the document on the contact glass while the scanner unit is moved in the sub-scanning direction, is fixed at the reading position of the SDF contact glass, and it is processed while the document is delivered by the SDF through the SDF contact glass, so that the document is optically read with the scanner unit provided below.

In addition, Japanese Laid-Open Patent Application No. 2000-196881, Japanese Laid-Open Patent Application No. 2000-201260, and Japanese Laid-Open Patent Application No. 11-220591 disclose the background technology related to the present invention.

In order to attain the miniaturization of the above-mentioend image reading devices equipped with the SDF, the document transport path of the SDF is arranged such that the document is reversed through the delivery of the docment in the transport path.

For this reason, the document is lifted-on the SDF contact glass under the influence of the rigidity of the document or original sheet at the reading position of the SDF contact glass, and the problem that the document is not flush with the SDF contact glass surface is likely to take place.

In many cases, the document is lifted on the SDF contact glass when the SDF reading mode is carried out. Generally, when compared with the traditional reading mode in which the document is pressed down on the contact glass under the pressure from the upper document plate and optically read, the SDF reading mode often casues the reproduced image to become comparatively dark because of the lifting of the document from the SDF contact glass surface.

Moreover, the irradiation conditions of the illuminating lamp over the document in the SDF reading mode are changed from those in the traditional reading mode, and even when the same document is optically read, the readout level or the output level of the read data signal in the SDF reading mode is different from that in the traditional reading mode.

### SUMMARY OF THE INVENTION

An object of the present invention is to provide an improved image reading device in which the above-described problems are eliminated.

Another object of the present invention is to provide an image reading device equipped with the SDF which is able to optimize the readout level (the output level of the read data signal) of the SDF reading mode so as to minimize the difference between the readout level of the SDF reading mode and the readout level of the traditional reading mode.

Another object of the present invention is to provide an image forming apparatus including an image reading device equipped with the SDF which is able to optimize the readout level of the SDF reading mode so as to minimize the difference between the readout level of the SDF reading mode and the readout level of the traditional reading mode.

The above-mentioned objects of the present invention are achieved by an image reading device having a first reading mode and a second reading mode in which the first reading mode is performed with a reading optical unit being fixed to read a document being transported and the second reading mode is performed with the reading optical unit being moved to read a document fixed to the image reading device, the image reading device comprising: a photoelectric conversion unit converting image data, optically read from a document, into an analog signal; the reading optical unit irradiating light to the document and directing a reflected light from the document to the photoelectric conversion unit; an analog-signal processing unit sampling the analog signal outputted by the photoelectric conversion unit, and performing gain adjustment of the sampled analog signal in response to a control signal; an analog-to-digital conversion unit converting the analog signal, outputted by the analog-signal processing unit, based on a reference voltage so that the analog-to-digital conversion unit outputs a digital signal of the read data at an output level; and a correction unit optimizing the output level of the read data signal for each of the first reading mode and the second reading mode by changing either the control signal outputted to the analog-signal processing unit or the reference voltage outputted to the analog-to-digital conversion unit.

The above-mentioned objects of the present invention are achieved by an image reading device having a first reading mode and a second reading mode in which the first reading mode is performed with a reading optical unit being fixed to read a document being transported and the second reading mode is performed with the reading optical unit being moved to read a document fixed to the image reading device, the image reading device comprising: a photoelectric conversion unit converting image data, optically read from a document, into an analog signal; the reading optical unit irradiating light to the document and directing a reflected light from the document to the photoelectric conversion unit; an analog-signal processing unit sampling the analog signal outputted by the photoelectric conversion unit, and performing gain adjustment of the sampled analog signal in response to a control signal; an analog-to-digital conversion unit converting the analog signal, outputted by the analog-signal processing unit, based on a reference voltage so that the analog-to-digital conversion unit outputs a digital signal of the read data at an output level; and a correction unit optimizing the output level of the read data signal for each of the first reading mode and the second reading mode so that the output level of the read data signal for the first reading mode and the output level of the read data signal for the second reading mode are equivalent to each other.

The above-mentioned objects of the present invention are achieved by an image forming apparatus comprising: an image reading device; and an image formation unit forming a visible image on an image recording medium based on an image data signal outputted by the image reading device, the image reading device having a first reading mode and a second reading mode in which the first reading mode is performed with a reading optical unit being fixed to read a document being transported and the second reading mode is performed with the reading optical unit being moved to read a document fixed to the image reading device, the image reading device comprising: a photoelectric conversion unit converting image data, optically read from a document, into an analog signal; the reading optical unit irradiating light to the document and directing a reflected light from the document to the photoelectric conversion unit; an analog-signal processing unit sampling the analog signal outputted by the photoelectric conversion unit, and performing gain adjustment of the sampled analog signal in response to a control signal; an analog-to-digital conversion unit converting the analog signal, outputted by the analog-signal processing unit, based on a reference voltage so that the analog-to-digital conversion unit outputs a digital signal of the read data at an output level; and a correction unit optimizing the output level of the read data signal for each of the first reading mode and the second reading mode by changing either the control signal outputted to the analog-signal processing unit or the reference voltage outputted to the analog-to-digital conversion unit.

According to the image reading device and the image forming apparatus of the present invention, it is possible to optimize the output level of the read data signal when the document is optically read, irrespective of whether the document is read in the SDF reading mode (the first reading mode) or the traditional reading mode (the second reading mode). Moreover, according to the present invention, the difference between the readout level of the first reading mode and the readout level of the second reading mode is made as small as possible by the image reading device, and the quality of image formation can be stabilized based on the kind of the document being read.

### BRIEF DESCRIPTION OF THE DRAWINGS

Other objects, features and advantages of the present invention will be apparent from the following detailed description when read in conjunction with the accompanying drawings.

FIG. 1 is a diagram showing an image forming apparatus to which one embodiment of an image reading device using a sheet-through document feeder is applied.

FIG. 2 is a diagram showing a portion of the image forming apparatus of FIG. 1 in the vicinity of the reading position.

FIG. 3 is a block diagram showing the composition of image data processing in the image forming apparatus of FIG. 1.

FIG. 4 is a block diagram of a sensor board in the image reading apparatus of FIG. 1 which outputs a digital image signal in response to the CCD output signal.

FIG. 5 is a flowchart for explaining a control procedure of the first preferred embodiment of the present invention.

FIG. 6 is a flowchart for explaining a control procedure of the second preferred embodiment of the present invention.

FIG. 7 is a flowchart for explaining a control procedure of the third preferred embodiment of the present invention.

FIG. 8 is a flowchart for explaining a control procedure of the fourth preferred embodiment of the present invention.

FIG. 9 is a flowchart for explaining a control procedure of the fifth preferred embodiment of the present invention.

FIG. 10A and FIG. 10B are diagrams for explaining the relationship between the document reflectivity and the read data signal level.

FIG. 11 is a flowchart for explaining a control procedure of the sixth preferred embodiment of the present invention.

### DETAILED DESCRIPTION OF PREFERRED EMBODIMENTS

A description will now be provided of the preferred embodiments of the present invention with reference to the accompanying drawings.

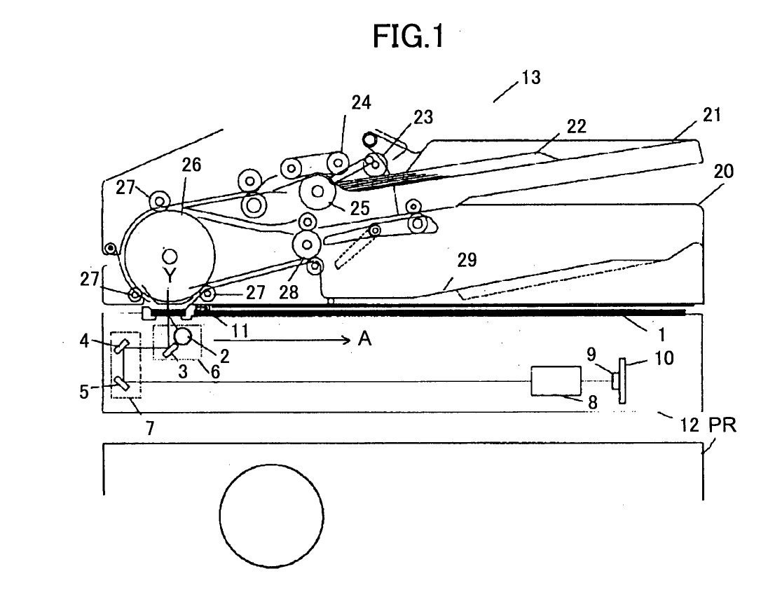

FIG. 1 shows the principal part of an image forming apparatus to which one embodiment of the image reading device of the present invention using the sheet-through document feeder (SDF) is applied.

In the image forming apparatus of FIG. 1, the internal composition of the image reading device (hereinafter, called also the scanner) is illustrated, and the image reading device is arranged on the upper part of the printer PR which constitutes an image formation unit of the image forming apparatus.

The scanner 13 which constitutes the image reading device in the present embodiment includes a reader module 12 and an SDF (sheet-through document feeder) 20 attached to the upper part of the reader module 12.

The reader module 12 includes a contact glass 1, a first carriage 6, a second carriage 7, a lens unit 8, a sensor board 10, and a white reference board 11. The contact glass 1 is provided as the document plate to place the document thereon. The first carriage 6 includes an illuminating lamp 2 for irradiating light to the document and a first reflective mirror 3. The second carriage 7 includes a second reflective mirror 4 and and a third reflective mirror 5. The lens unit 8 is provided to focus the reflected light from the document onto a CCD linear image sensor 9 (called the CCD 9). The CCD 9 is provided to carry out the photoelectric conversion of the focused light into an analog signal. The sensor board 10 is provided to arrange the CCD 9 thereon. The white reference board 11 is provided for correcting various optical distortions caused by the reading optical unit.

When carrying out the image reading of the document placed on and fixed to the contact glass 1, the first carriage 6 is moved in the forward direction (indicated by the arrow A in FIG. 1) at a fixed speed and the second carriage 7 is moved to follow the movement of the first carriage 6 at a speed that is half the speed of the first carriage 6. The document placed on the contact glass 1 is optically scanned without changing the optical path length.

After the image reading of the document is performed, the first carriage 6 and the second carriage 7 are moved in the backward direction to their home position. The position of the first carriage 6 and the second carriage 7 shown in FIG. 1 is the home position mentioned above.

In addition, the reader module 12 is provided with a motor drive system (not shown in FIG. 1) which moves the first carriage 6 and the second carriage 7 as described above.

In the SDF 20, the document sheets 22 set on the document tray 21 are delivered to the separation position by the pickup roller 23. At the separation position, the document sheets are separated into each sheet by the feed roller 24 and the separation roller 25, and it is delivered in the SDF 20. While the document is pinched between the transport drum 26 as a feed roller and the follower rollers 27, and the document is delivered along the periphery of the transport drum 26. The follower rollers 27 are pressed on the transport drum 26.

In the delivery of the document; when the reading position (the home position) Y, as indicated in FIG. 1, is reached, the bottom surface (the image-carrying side) of the document is irradiated by the illuminating lamp 2 at a predetermined time, and the reflected light from the document is directed to the CCD 9 through the first reflective mirror 3, the second reflective mirror 4 and the third reflective mirror 5. The photoelectric conversion of the focused light into the analog signal is carried out by the CCD 9 in a manner similar to the above-mentioned operation.

The document is delivered toward the right-hand side of FIG. 1 by the transport drum 26 and the follower rollers 27, and the reflected light from the document is incident to the CCD 9 so that the document is optically scanned in the sub-scanning direction of the document.

The document after the image reading is performed is delivered to the ejection tray 29 by the ejection rollers 28.

The scanner 13 which is configured as mentioned above is arranged on the upper part of the printer PR which constitutes the image formation unit of the image forming apparatus. The image data is read from the document by the CCD 9, and the necessary image processing of the read image data is performed by the image-processing integrated circuit provided on the sensor board 10. The processed image data needed for the printing of the reproduced image is outputted to the optical writing unit (which will be described later) of the printer PR. The optical writing of the processed image data to an image recording medium of the printer is performed by the optical writing unit using the laser didoe (LD), so that a visible image is electrostatically formed on the image recording medium.

The printer PR is not limited to the above-described embodiment including the optical writing unit using the laser didoe (LD). Alternatively, a printing unit of a different type which performs the image formation on the image recording medium by means of a printing head utilizing the known ink-jet printing method or the known thermal printing method may be used for the image forming apparatus of the present invention instead of the above-described embodiment.

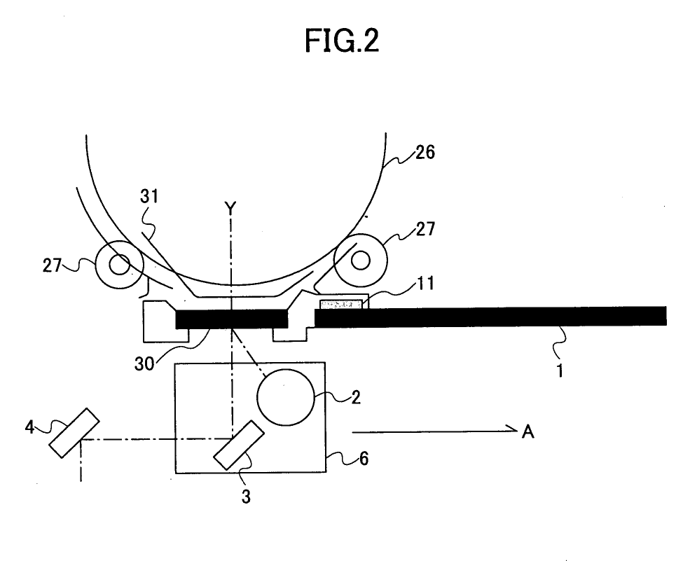

FIG. 2 shows a portion of the image forming apparatus of FIG. 1 in the vicinity of the reading position Y.

As shown in FIG. 2, an SDF contact glass 30 is provided at the reading position Y, and the SDF contact glass 30 confronts the transport drum 26 and is located adjacent to the contact glass 1. Moreover, the SDF contact glass 30 is located at the upstream position from the position of the contact glass 1 with respect to the forward direction, indicated by the arrow A in FIG. 2, in which the first carriage 6 is moved when the image reading is performed. An upper guide plate 31 is provided above the top surface of the SDF contact glass 30.

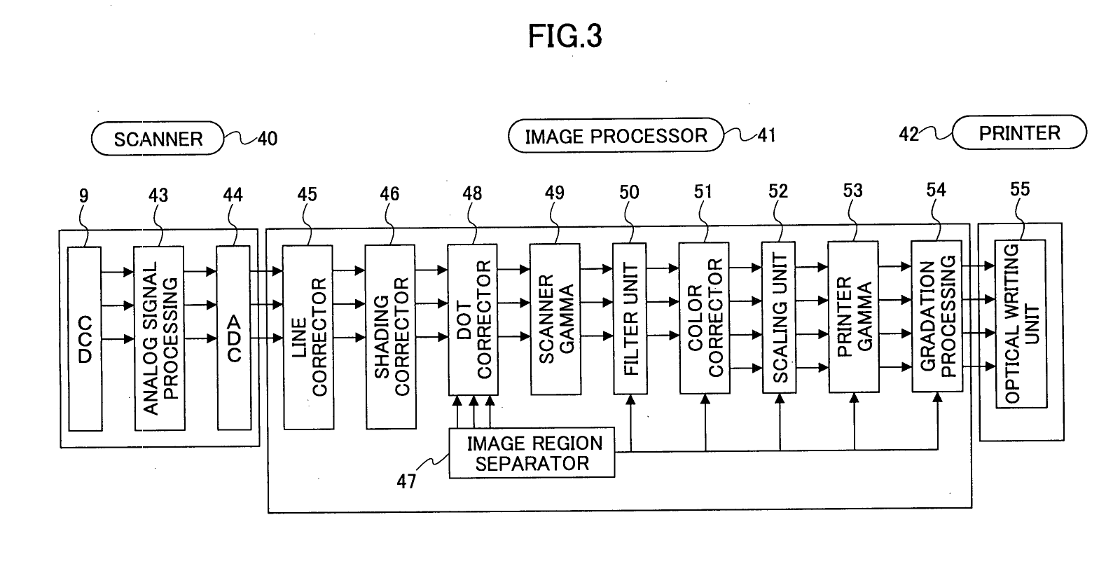

FIG. 3 shows the composition of image data processing in the image forming apparatus of FIG. 1.

In the image forming apparatus of FIG. 1, the image data is optically read from the document by the scanner 40, a predetermined image processing of the read image data is performed by the image processor unit 41, and the optical writing of the processed image data to the image recording medium is performed by the printer unit 42.

As shown in FIG. 3, the scanner 40 is comprised of the CCD 9, the analog-signal processing unit 43, and the A/D converter (ADC) 44. The CCD 9 is a color 3-line CCD unit in which the CCD sensors covered with the filters of RGB are arranged in three lines.

In the analog-signal processing unit 43, the analog signal outputted by the CCD 9 is sampled. The amplifier is provided in the analog-signal processing unit 43, and the analog-signal processing unit 43 performs gain adjustment of the output signal in response to a control signal.

In the A/D converter 44, the analog image signals of R, G and B are converted into a 8-bit color digital image signal, and the A/D converter 44 outputs the digital image signal to the image processor unit 41.

As shown in FIG. 3, the image processor unit 41 is comprised of the line corrector 45, the shading corrector 46, the dot corrector 48, the scanner gamma unit 49, the filter unit 50, the color corrector 51, the scaling unit 52, the printer gamma unit 53, the gradation processing unit 54, and the image-region separator 47. The image processor unit 41 outputs the processed image data in which gradation processing is performed by the gradation processing unit 54, to the printer unit 42.

In the present embodiment, the 3-line CCD 9 is provided in the scanner unit 40 as mentioned above. The output signal of the 3-line CCD 9 contains the position gap of the four-line interval when the scaling is unchanged. For example, there are position gaps at intervals of eight lines between R and G signals, and the line corrector 45 stores the data of the eight lines of R signal, and stores the data of the four lines of G signal and delays so that the position gaps between the lines are corrected.

In the shading correcting unit 46, the correction of optical density irregularity of the optical system and the sensitivity variation of the CCD 9 is performed for each RGB signal. When the scaling is changed, there is the case in which the position gap is not suitably corrected by the line corrector 45 only. In the dot corrector 48, the position gap of one line or less which cannot be corrected by the line corrector 46 is corrected by making reference to the surrounding pixels.

In the scanner gamma unit 49, the data having linear characteristics with respect to the document reflectivity is transformed into data having characteristics that improve the precision of the color correction performed by the subsequent color corrector 51.

In the image-region separator 47, in order to optimize the subsequent stage processing such that the processing is suited to the feature of the image, it is determined whether the picture element of concern is in the character region or in the picture region.

In the filter unit 50, in order to make the character region sharp, the edge is emphasized, and in order to smooth the picture region, the smoothing processing is performed.

In the color corrector 51, the image signals of R, G, and B which are outputted by the CCD 9 are transformed into the image signals of C, M, Y, and K. Since the sensitivity of the CCD 9 and the characteristics of color inks differ from the ideal conditions, the color-correction parameters are adjusted in the copying machine so that the differences between the iamge signals with the document colors are corrected.

In the scaling unit 52, the scaling in the main scanning direction of the document is performed. In this case, by using the convolution method, the scaling processing is performed with the MTF of the reading optical system held, and the resolution of the image data is maintained. As for the sub-scanning direction of the document, the scaling is performed by controlling the scanning speed of the document in the sub-scanning direction.

In addition, the convolution method is well known in the art, and a description thereof will be omitted.

In the printer gamma unit 53, the processing is performed which makes the difference of the spectral characteristics of the document and the toner, the gray balance, and the top optical density proper such that the original optical density and the copy optical density are made in agreement.

In the gradation processing unit 54, the 8-bit optical density information is transformed into bi-level or multi-level image data. In this case, the bi-level or multi-level image data is created for the character region, and dithering processing or error diffusion processing is performed for the picrture region. The gradation processing unit 54 outputs the resulting image data to the printer unit 42.

In the printer unit 42, laser writing of the image data of C, M, Y and K to the image recording medium is carried out by the optical writing unit 55, and the reproduced image is printed onto the copy sheet a predetermined image-formation process.

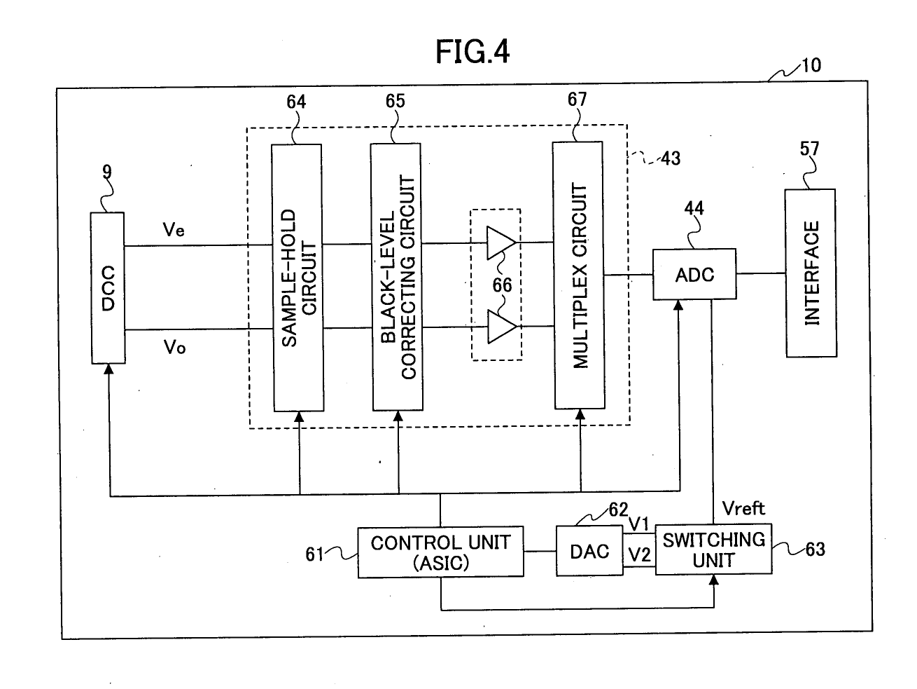

FIG. 4 is a block diagram of the sensir board 10 which generates a digital image signal from the CCD output signal.

Synchronized with the drive pulse, the CCD 9 outputs the image signals Ve and Vo to the sample-hold circuit 64, and the image signals Ve and Vo are sampled and held by the sample-hold circuit 64 to form the continuous analog signal according to the sampling pulse.

In the black level correcting circuit 65, the variation of the dark level of the output signals of the CCD 9 is corrected. In the amplifiers 66, the output levels of the odd-number and even-number pixel data of each chrominance signal are matched at a fixed output level. In the multiplexing circuit 67, the multiplexing of the odd-number and even-number pixel data is carried out. In the A/D converter 44, the multiplexed signal is converted into the digital image data. The image data is outputted from the A/D converter 44 to the following image-processor unit through the interface 57.

The control unit 61 which is an ASIC (application-specific integrated circuit) generates control signals needed to drive the operation of the CCD 9 and other circuits. In the case of the 3-line CCD 9, the circuit composition that is the same as described above is provided for each of the RGB image signals.

The shading correction processing performed by the shading corrector 46 is to generate shading data by reading the white reference board 11 before reading the image from the document. The shading data is stored in the memory, and the shading correction processing between the read data “D” and the shading data “Sd” at each reading position of the main scanning direction is performed per dot.

When the data of each dot has 8 bits of image information, the data after the shading correction is performed is represented by the following equation: Data=D/Sd×255 (1).

In this case, the reference top voltage Vreft to the A/D converter 44 is changed by the switching unit 63 between the voltage V1 when the shading data Sd is generated and the voltage V2 when the image reading is performed to generate the read data D. By the switching operation, the voltage V1 is outputted to the A/D converter 44 as the reference top voltage Vreft at the time of generating the shading data Sd, and the voltage V2 is outpted to the A/D converter 44 as the reference top voltage Vreft at the time of generating the read data D.

The adjustment of the reference voltage is performed for the scanner 40 at the time of factory adjustment such that the criteria chart sheet is read and the reference top voltage Vreft-V2 at the time of the image reading is adjusted to the desired value for a certain reflection factor.

The adjustment of the reference voltage for the scanner 40 is performed for every model to eliminate the variations of the respective models in the optical reading level. The reference voltages V1 and V2 are set up in the DA converter 62 by the control unit 61 at the time of initialization, and the reference voltages are supplied to the switching unit 63.

A descrption will be given of the first preferred embodiment of the present invention.

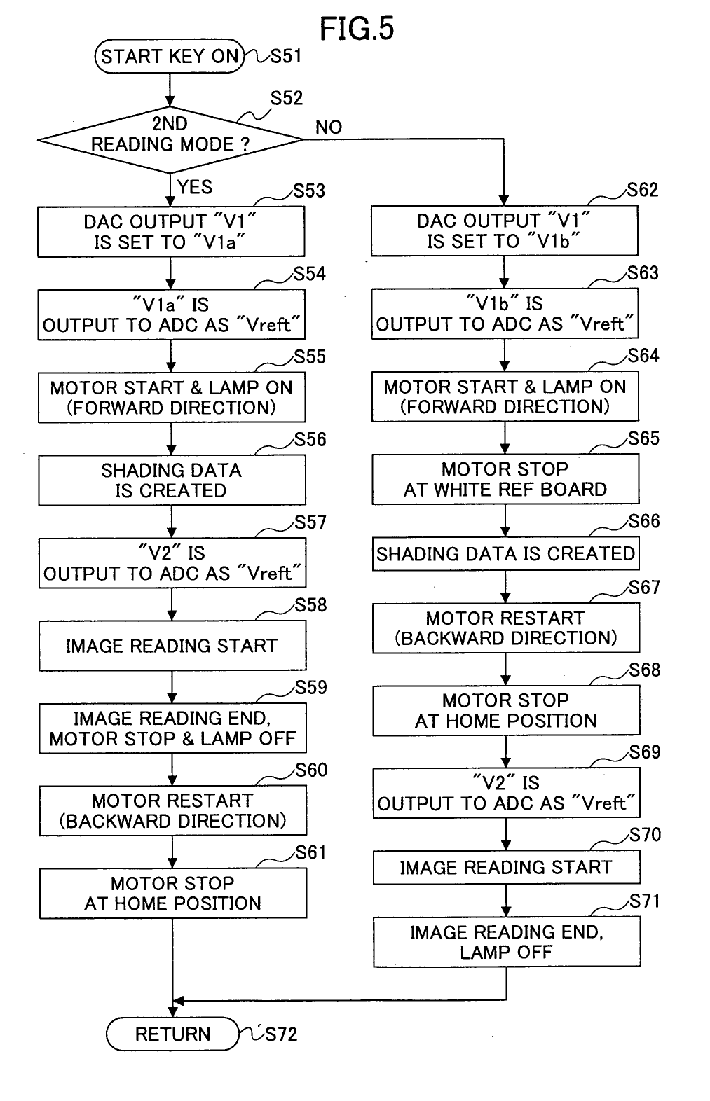

FIG. 5 is a flowchart for explaining a control procedure of the first preferred embodiment of the present invention. In the control procedure, the dynamic range of the A/D converter 44 at the time of shading data generation is changed according to a selected one of the first reading mode (also called the SDF reading mode) which uses the SDF to perform the image reading and the second reading mode (also called the tranditional reading mdoe) which sets the document on the document plate (the contact glass 1) to perform the image reading.

The control procedure of FIG. 5 is started by the control unit 61 (or a system controller not shown) when the start key of the image forming apparatus is set in ON state in order to perform the copier function (S51). For the sake of convenience, in the following description, it is assumed that the control procedure of the present embodiment is carried out by the control unit 61 although it may be carried out by the system controller instead.

The control unit 61 determines whether the document is set on the contact glass 1 to perform the image reading, or it determines whether the second reading mode is selected (S52).

When the result of the determination at step S52 is affirmative (the second reading mode), the control unit 61 selects the output voltage V1 of the DAC 62 and sets the output voltage V1 to a given reference voltage V1a for the second reading mode (S53).

Then, the control unit 61 causes the switching unit 63 to output the reference voltage V1a to the A/D converter 44 as the reference top voltage Vreft (S54).

After the step S54 is performed, the control unit 61 starts the carriage motor and sets the illuminating lamp 2 in ON state so that the first carriage 6 and the second carriage 7 are moved in the forward direction (S55).

When the first carriage 6 reaches the white reference board 11, the control unit 61 causes the shading corrector 46 to generate the shading data Sd by scanning the white reference board 11 (S56).

After the shading data is created, the control unit 61 causes the switching unit 63 to output the reference voltage V2 to the A/D converter 44 as the reference top voltage Vreft (S57).

When the first carriage 6 reaches the front-end edge of the document on the contact glass 1, the control unit 61 starts the image reading of the document (S58).

When the first carriage 6 reaches the rear-end edge of the document, the control unit 61 terminates the image reading of the document by stopping the carriage motor and setting the illuminating lamp 2 in OFF state (S59).

After the step S59 is performed, the control unit 61 causes the first carriage 6 and the second carriage 7 to be moved in the backward direction (S60).

When the first carriage 6 and the second carriage 7 arrive at the home position, the control unit 61 stops the carriage motor (S61). Then, the second reading mode operation is terminated (S72).

On the other hand, when the result of the determination at step S52 is negative, the first reading mode operation is started to perform the image reading of the document using the SDF 20. The control unit 61 selects the output voltage V1 of the DAC 62 and sets the output voltage V1 to a given reference voltage V1b for the first reading mode (S62).

Then, the control unit 61 causes the switching unit 63 to output the reference voltage V1b to the A/D converter 44 as the reference top voltage Vreft (S63).

After the step S63 is performed, the control unit 61 starts the carriage motor and sets the illuminating lamp 2 in ON state so that the first carriage 6 and the second carriage 7 are moved in the forward direction of the document (S64).

When the first carriage 6 reaches the white reference board 11, the control unit 61 stops the carriage motor (S65).

Then, the control unit 61 causes the shading corrector 46 to generate the shading data Sd by scanning the white reference board 11 (S66).

After the shading data Sd is created, the control unit 61 causes the carriage motor to be restarted so that the first carriage 6 and the second carriage 7 are moved in the backward direction of the document (S67).

When the first carriage 6 and the second carriage 7 arrive at the home position, the control unit 61 stops the carriage motor (S68).

After the step S68 is performed, the control unit 61 causes the switching unit 63 to output the reference voltage V2 to the AID converter 44 as the reference top voltage Vreft (S69).

When the front-end edge of the document delivered by the SDF 20 reaches the SDF contact glass 30, the control unit 61 starts the image reading of the document (S70). When the rear-end edge of the document delivered by the SDF 20 reaches the SDF contact glass 30, the control unit 61 terminates the image reading, of the document by setting the lamp 2 in OFF state (S71). Then, the first reading mode operation using the SDF is terminated (S72).

In the control procedure of FIG. 5, the reference top voltage Vreft outputted to the A/D converter 44 which is used at the time of the shading data generating is changed at the steps S53 and S62 between the reference voltage V1a for the second reading mode and the reference voltage V1b for the first reading, mode.

In the SDF reading mode, the image reading of the document is performed with the reading optical unit at the home position. The output level of the read data signal in the SDF reading mode is usually smaller than that in the traditional reading mode under the influence of the lifting of the document and the different irradiation conditions of the illuminating lamp.

It is necessary that the shading correction processing is performed according to the above-mentioned formula (1). In order to eliminate the problem, the image reading device of the present embodiment is configured so that the dynamic range of the A/D converter 44 at the time of shading data generation in the SDF reading mode is widened in comparison with that in the traditional reading mode.

Namely, it is adequate that the image reading device of the present embodiment is configured such that the condition V1a<V1b is met. According to the present embodment, it is possible to raise the brightness of the image data in the SDF reading mode after the shading correction is performed.

The ratio of the reference voltages V1a and V1b may be preset to the value calculated through the experiment. Alternatively, it may be adjusted at the time of factory adjustment by reading the same document for both the traditional reading mode and the SDF reading mode and setting the ratio so that the output levels of the read data signals for the both modes may become the same.

Furthermore, the image forming apparatus in the present embodment may be configured to include an operation panel that allows the user or the service person to set the kind of the document. The image reading device of the present embodiment is provided to change the dynamic range of the A/D converter 44 depending on the kind of the document set by the user or the service person.

Therefore, according to the first preferred embodiment, the improved shading correction control is included in the image reading device, and the difference in the output level of the read data signal between the first reading mode and the second reading mode can be minimized by changing the dynamic range of the A/D converter at the time of shading data generation according to the selected one of the first reading mode and the second reading mode.

Next, a description will be given of the second preferred embodiment of the present invention.

The composition and functions of the image forming apparatus and the image reading device of the second preferred embodiment are essentially the same as those described above with reference to FIG. 1 through FIG. 4, and a duplicate description thereof will be omitted.

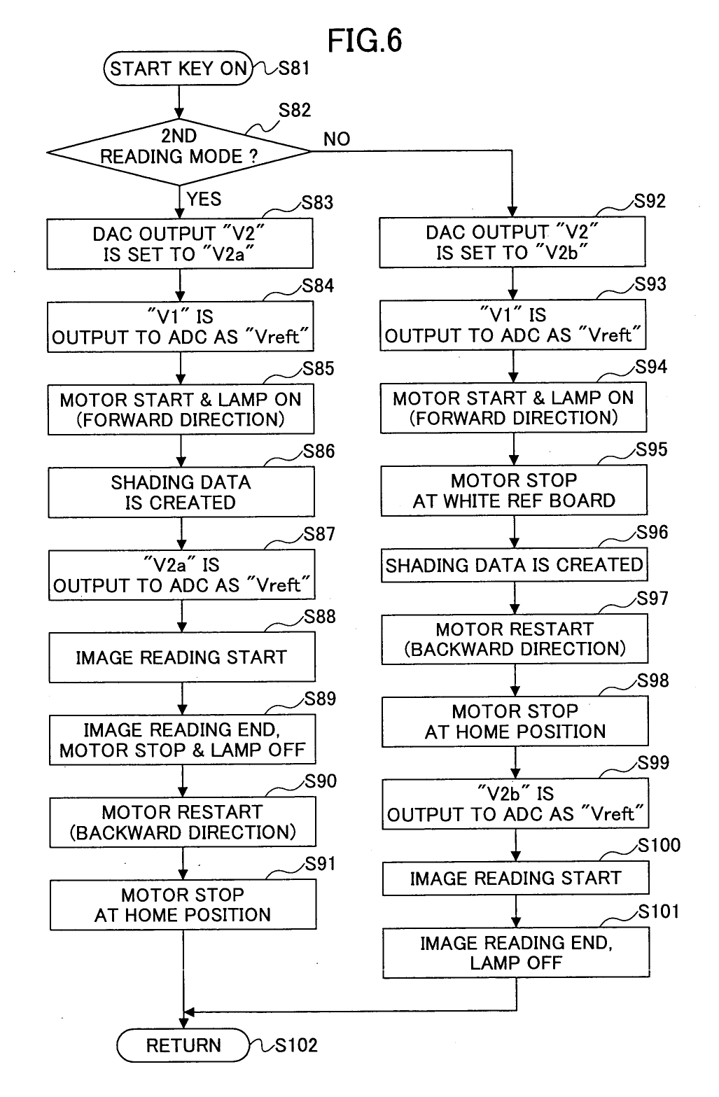

FIG. 6 is a flowchart for explaining a control procedure of the second preferred embodiment of the present invention. In the control procedure, the dynamic range of the A/D converter 44 at the time of image data reading is changed according to a selected one of the first reading mode which uses the SDF to perform the image reading and the second reading mode which sets the document on the contact glass 1 to perform the image reading.

The control procedure of FIG. 6 is started by the control unit 61 (or the system controller) when the start key of the image forming apparatus is set in ON state in order to perform the copier function (S81). The control unit 61 determines whether the document is set on the contact glass 1 to perform the image reading, or it determines whether the second reading mode is selected (S82).

When the result of the determination at step S82 is affirmative (the second reading mode), the control unit 61 selects the output voltage V2 of the DAC 62 and sets the output voltage V2 to a given reference voltage V2a for the second reading mode (S83).

Then, the control unit 61 causes the switching unit 63 to output the reference voltage V1 to the A/D converter 44 as the reference top voltage Vreft (S84).

After the step S84 is performed, the control unit 61 starts the carriage motor and sets the illuminating lamp 2 in ON state so that the first carriage 6 and the second carriage 7 are moved in the forward direction (S85).

When the first carriage 6 reaches the white reference board 11, the control unit 61 causes the shading corrector 46 to generate the shading data Sd by scanning the white reference board 11 (S86).

After the shading data is created, the control unit 61 causes the switching unit 63 to output the given reference voltage V2a to the A/D converter 44 as the reference top voltage Vreft (S87).

When the first carriage 6 reaches the front-end edge of the document on the contact glass 1, the control unit 61 starts the image reading of the document (S88).

When the first carriage 6 reaches the rear-end edge of the document, the control unit 61 terminates the image reading of the document by stopping the carriage motor and setting the illuminating lamp 2 in OFF state (S89).

After the step S89 is performed, the control unit 61 causes the first carriage 6 and the second carriage 7 to be moved in the backward direction (S90).

When the first carriage 6 and the second carriage 7 arrive at the home position, the control unit 61 stops the carriage motor (S91). Then, the second reading mode operation is terminated (S102).

On the other hand, when the result of the determination at step S82 is negative, the first reading mode operation is started to perform the image reading of the document using the SDF 20. The control unit 61 selects the output voltage V2 of the DAC 62 and sets the output voltage V2 to a given reference voltage V2b for the first reading mode (S92).

Then, the control unit 61 causes the switching unit 63 to output the reference voltage V1 to the A/D converter 44 as the reference top voltage Vreft (S93).

After the step S93 is performed, the control unit 61 starts the carriage motor and sets the illuminating lamp 2 in ON state so that the first carriage 6 and the second carriage 7 are moved in the forward direction (S94).

When the first carriage 6 reaches the white reference board 11, the control unit 61 stops the carriage motor (S95).

Then, the control unit 61 causes the shading corrector 46 to generate the shading data Sd by scanning the white reference board 11 (S96).

After the shading data Sd is created, the control unit 61 causes the carriage motor to be restarted so that the first carriage 6 and the second carriage 7 are moved in the backward direction of the document (S97).

When the first carriage 6 and the second carriage 7 arrive at the home position, the control unit 61 stops the carriage motor (S98).

After the step S98 is performed, the control unit 61 causes the switching unit 63 to output the given reference voltage V2b to the A/D converter 44 as the reference top voltage Vreft (S99).

When the front-end edge of the document delivered by the SDF 20 reaches the SDF contact glass 30, the control unit 61 starts the image reading of the document (S100). When the rear-end edge of the document delivered by the SDF 20 reaches the SDF contact glass 30, the control unit 61 terminates the image reading of the document by setting the lamp 2 in OFF state (S101). Then, the first reading mode operation using the SDF is terminated (S102).

In the control procedure of FIG. 6, the reference top voltage Vreft outputted to the A/D converter 44 which is used at the time of the image data reading is changed at the steps S83 and S92 between the reference voltage V2a for the second reading mode and the reference voltage V2b for the first reading mode.

In the SDF reading mode, the image reading of the document is performed with the reading optical unit at the home position. The output level of the read data signal in the SDF reading mode is usually smaller than that in the traditional reading mode under the influence of the lifting of the document and the different irradiation conditions of the illuminating lamp.

It is necessary that the shading correction processing is performed according to the above-mentioned formula (1). In order to eliminate the problem, the image reading device of the present embodiment is configured so that the dynamic range of the A/D converter 44 at the time of image reading in the SDF reading mode is narrowed in comparison with that in the traditional reading mode.

Namely, it is adequate that the image reading device of the present embodiment is configured such that the condition V2a>V2b is met. According to the present embodment, it is possible to raise the brightness of the image data in the SDF reading mode after the shading correction is performed.

The ratio of the reference voltages V2a and V2b may be preset to the initial value calculated through the experiment. Alternatively, it may be adjusted at the time of factory adjustment by reading the same document for both the traditional reading mode and the SDF reading mode and setting the ratio so that the output levels of the read data signals for the both modes may become the same.

Furthermore, the image forming apparatus in the present embodment may be configured to include an operation panel that allows the user or the service person to set the kind of the document. The image reading device of the present embodiment is provided to change the dynamic range of the A/D converter 44 depending on the kind of the document set by the user or the service person.

Therefore, according to the second preferred embodiment, the difference in the output level of the read data signal between the first reading mode and the second reading mode can be minimized by changing the dynamic range of the A/D converter at the time of image reading according to the selected one of the first reading mode and the second reading mode.

Next, a description will be given of the third preferred embodiment of the present invention.

The composition and functions of the image forming apparatus and the image reading device of the third preferred embodiment are essentially the same as those described above with reference to FIG. 1 through FIG. 4, and a duplicate description thereof will be omitted.

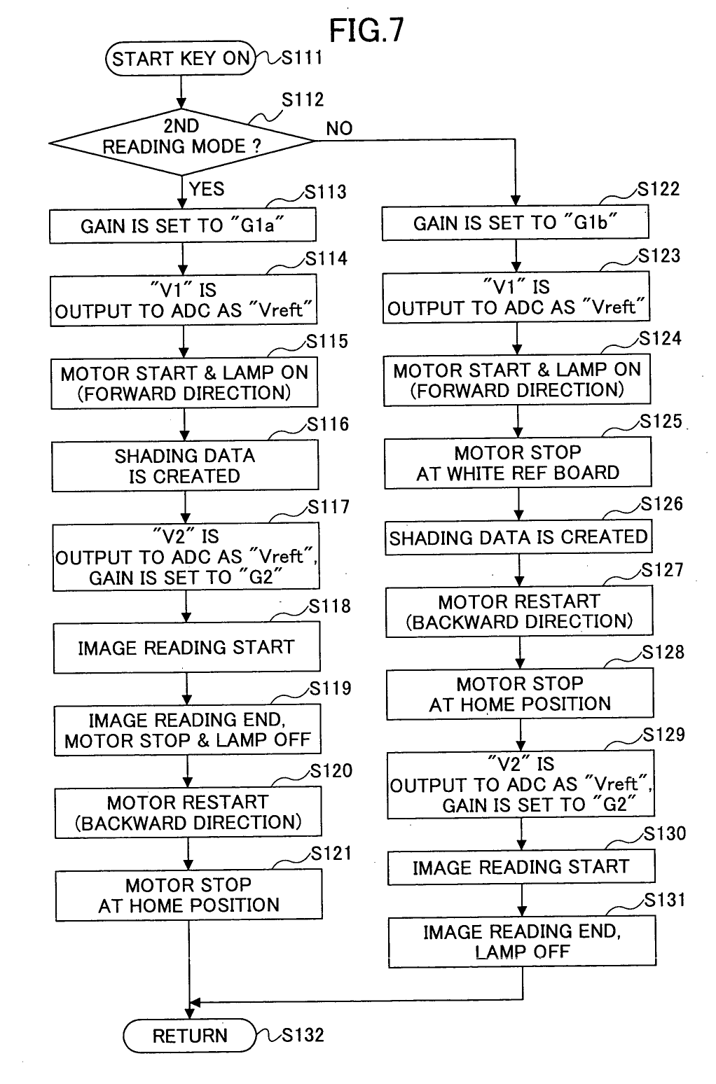

FIG. 7 is a flowchart for explaining a control procedure of the third preferred embodiment of the present invention. In the control procedure, the gain of the analog-signal processing unit 43 at the time of shading data generation is changed according to a selected one of the first reading mode which uses the SDF to perform the image reading and the second reading mode which sets the document on the contact glass 1 to perform the image reading.

The control procedure of FIG. 7 is started by the control unit 61 (or the system controller) when the start key of the image forming apparatus is set in ON state in order to perform the copier function (S111). The control unit 61 determines whether the document is set on the contact glass 1 to perform the image reading, or it determines whether the second reading mode is selected (S112).

When the result of the determination at step S112 is affirmative (the second reading mode), the control unit 61 sets the gain of the analog-signal processing unit 43 to a given gain G1a for the second reading mode (S113).

Then, the control unit 61 causes the switching unit 63 to output the reference voltage V1 to the A/D converter 44 as the reference top voltage Vreft (S114).

After the step S114 is performed, the control unit 61 starts the carriage motor and sets the illuminating lamp 2 in ON state so that the first carriage 6 and the second carriage 7 are moved in the forward direction (S115).

When the first carriage 61 reaches the white reference board 11, the control unit 61 causes the shading corrector 46 to generate the shading data Sd by scanning the white reference board 11 (S116).

After the shading data is created, the control unit 61 sets the gain of the analog-signal processing unit 43 to a given gain G2 and causes the switching unit 63 to output the reference voltage V2 to the A/D converter 44 as the reference top voltage Vreft (S117).

When the first carriage 6 reaches the front-end edge of the document on the contact glass 1, the control unit 61 starts the image reading of the document (S118).

When the first carriage 6 reaches the rear-end edge of the document, the control unit 61 terminates the image reading of the document by stopping the carriage motor and setting the illuminating lamp 2 in OFF state (S119).

After the step S119 is performed, the control unit 61 causes the first carriage 6 and the second carriage 7 to be moved in the backward direction (S120).

When the first carriage 6 and the second carriage 7 arrive at the home position, the control unit 61 stops the carriage motor (S121). Then, the second reading mode operation is terminated (S132).

On the other hand, when the result of the determination at step S112 is negative, the first reading mode operation is started to perform the image reading of the document using the SDF 20. The control unit 61 sets the gain of the analog-signal processing unit 43 to a given gain G1b for the first reading mode (S122).

Then, the control unit 61 causes the switching unit 63 to output the reference voltage V1 to the A/D converter 44 as the reference top voltage Vreft (S123).

After the step S123 is performed, the control unit 61 starts the carriage motor and sets the illuminating lamp 2 in ON state so that the first carriage 6 and the second carriage 7 are moved in the forward direction (S124).

When the first carriage 6 reaches the white reference board 11, the control unit 61 stops the carriage motor (S125).

Then, the control unit 61 causes the shading corrector 46 to generate the shading data Sd by scanning the white reference board 11 (S126).

After the shading data Sd is created, the control unit 61 causes the carriage motor to be restarted so that the first carriage 6 and the second carriage 7 are moved in the backward direction of the document (S127).

When the first carriage 6 and the second carriage 7 arrive at the home position, the control unit 61 stops the carriage motor (S128).

After the step S128 is performed, the control unit 61 sets the gain of the analog-signal processng unit 43 to the given gain G2 and causes the switching unit 63 to output the reference voltage V2 to the A/D converter 44 as the reference top voltage Vreft (S129).

When the front-end edge of the document delivered by the SDF 20 reaches the SDF contact glass 30, the control unit 61 starts the image reading of the document (S130). When the rear-end edge of the document delivered by the SDF 20 reaches the SDF contact glass 30, the control unit 61 terminates the image reading of the document by setting the lamp 2 in OFF state (S131). Then, the first reading mode operation using the SDF is terminated (S132).

In the control procedure of FIG. 7, the amplifier gain of the analog-signal processing unit 43 which is used at the time of shading data generation is changed at the steps S113 and S122 between the given gain G1a for the second reading mode and the given gain G1b for the first reading mode.

In the SDF reading mode, the image reading of the document is performed with the reading optical unit at the home position. The output level of the read data signal in the SDF reading mode is usually smaller than that in the traditional reading mode under the influence of the lifting of the document and the different irradiation conditions of the illuminating lamp.

It is necessary that the shading correction processing is performed according to the above-mentioned formula (1). In order to eliminate the problem, the image reading device of the present embodiment is configured so that the amplifier gain of the analog-signal processing unit 43 at the time of shading data generation in the SDF reading mode is made small in comparison with that in the traditional reading mode.

Namely, it is adequate that the image reading device of the present embodiment is configured such that the condition G1a>G1b is met. According to the present embodment, it is possible to raise the brightness of the image data in the SDF reading mode after the shading correction is performed. The gain G2 of the analog-signal processing unit 43 at the time of image reading in the traditional reading mode is almost equal to the gain G1a.

The ratio of the gains G1a and G1b may be preset to the initial value calculated through the experiment. Alternatively, it may be adjusted at the time of factory adjustment by reading the same document for both the traditional reading mode and the SDF reading mode and setting the ratio so that the output levels of the read data signals for the both modes may become the same.

Furthermore, the image forming apparatus in the present embodment may be configured to include an operation panel that allows the user or the service person to set the kind of the document. The image reading device of the present embodiment is provided to change the gain of the analog-signal processing unit 43 depending on the kind of the document set by the user or the service person.

Therefore, according to the third preferred embodiment, the difference in the output level of the read data signal between the first reading mode and the second reading mode can be minimized by changing the gain of the analog-signal processing unit at the time of shading data generation according to the selected one of the first reading mode and the second reading mode.

Next, a description will be given of the fourth preferred embodiment of the present invention.

The composition and functions of the image forming apparatus and the image reading device of the fourth preferred embodiment are essentially the same as those described above with reference to FIG. 1 through FIG. 4, and a duplicate description thereof will be omitted.

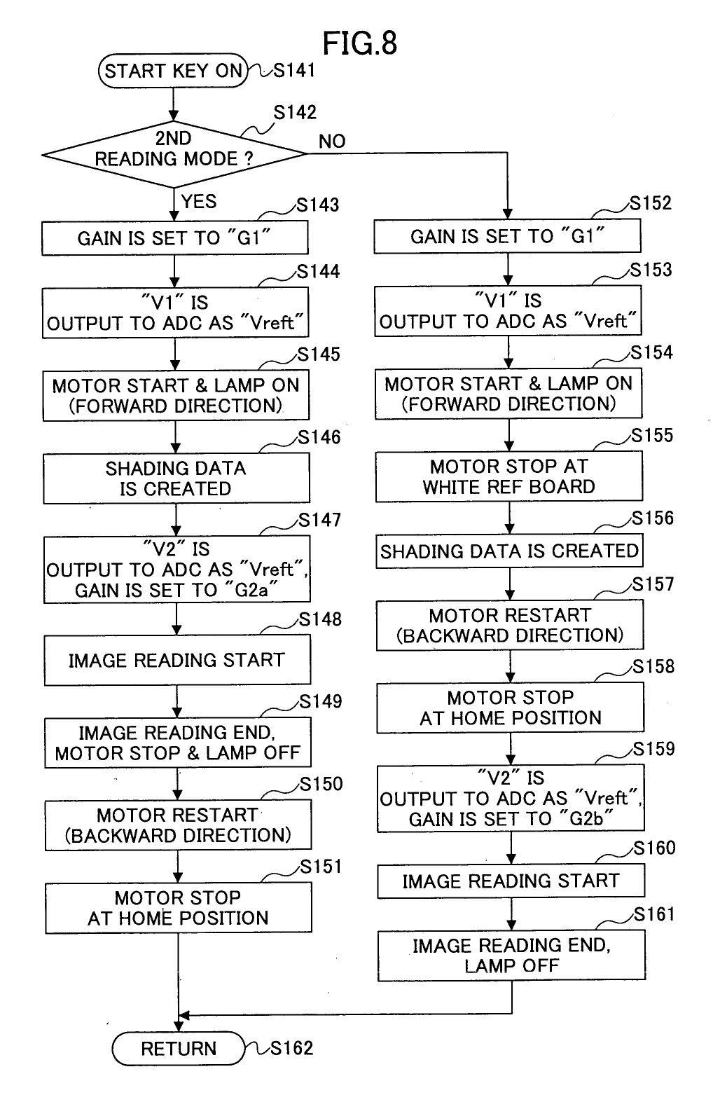

FIG. 8 is a flowchart for explaining a control procedure of the fourth preferred embodiment of the present invention. In the control procedure, the gain of the analog-signal processing unit 43 at the time of image reading is changed according to a selected one of the first reading mode which uses the SDF to perform the image reading and the second reading mode which sets the document on the contact glass 1 to perform the image reading.

The control procedure of FIG. 8 is started by the control unit 61 (or the system controller) when the start key of the image forming apparatus is set in ON state in order to perform the copier function (S141). The control unit 61 determines whether the document is set on the contact glass 1 to perform the image reading, or it determines whether the second reading mode is selected (S142).

When the result of the determination at step S142 is affirmative (the second reading mode), the control unit 61 sets the gain of the analog-signal processing unit 43 to the gain G1 for the second reading mode (S143).

Then, the control unit 61 causes the switching unit 63 to output the reference voltage V1 to the A/D converter 44 as the reference top voltage Vreft (S144).

After the step S144 is performed, the control unit 61 starts the carriage motor and sets the illuminating lamp 2 in ON state so that the first carriage 6 and the second carriage 7 are moved in the forward direction (S145).

When the first carriage 6 reaches the white reference board 11, the control unit 61 causes the shading corrector 46 to generate the shading data Sd by scanning the white reference board 11 (S146).

After the shading data is created, the control unit 61 sets the gain of the analog-signal processing unit 43 to a given gain. G2a and causes the switching unit 63 to output the reference voltage V2 to the A/D converter 44 as the reference top voltage Vreft (S147).

When the first carriage 6 reaches the front-end edge of the document on the contact glass 1, the control unit 61 starts the image reading of the document (S148).

When the first carriage 6 reaches the rear-end edge of the document, the control unit 61 terminates the image reading of the document by stopping the carriage motor and setting the illuminating lamp 2 in OFF state (S149).

After the step S149 is performed, the control unit 61 causes the first carriage 6 and the second carriage 7 to be moved in the backward direction (S150).

When the first carriage 6 and the second carriage 7 arrive at the home position, the control unit 61 stops the carriage motor (S151). Then, the second reading mode operation is terminated (S162).

On the other hand, when the result of the determination at step S142 is negative, the first reading mode operation is started to perform the image reading of the document using the SDF 20. The control unit 61 sets the gain of the analog-signal processing unit 43 to the gain G1 (S152).

Then, the control unit 61 causes the switching unit 63 to output the reference voltage V1 to the A/D converter 44 as the reference top voltage Vreft (S153).

After the step S153 is performed, the control unit 61 starts the carriage motor and sets the illuminating lamp 2 in ON state so that the first carriage 6 and the second carriage 7 are moved in the forward direction (S154).

When the first carriage 6 reaches the white reference board 11, the control unit 61 stops the carriage motor (S155).

Then, the control unit 61 causes the shading corrector 46 to generate the shading data Sd by scanning the white reference board 11 (S156).

After the shading data Sd is created, the control unit 61 causes the carriage motor to be restarted so that the first carriage 6 and the second carriage 7 are moved in the backward direction of the document (S157).

When the first carriage 6 and the second carriage 7 arrive at the home position, the control unit 61 stops the carriage motor (S158).

After the step S158 is performed, the control unit 61 sets the gain of the analog-signal processing unit 43 to a given gain G2b for the first reading mode and causes the switching unit 63 to output the reference voltage V2 to the A/D converter 44 as the reference top voltage Vreft (S159).

When the front-end edge of the document delivered by the SDF 20 reaches the SDF contact glass 30, the control unit 61 starts the image reading of the document (S160). When the rear-end edge of the document delivered by the SDF 20 reaches the SDF contact glass 30, the control unit 61 terminates the image reading of the document by setting the lamp 2 in OFF state (S161). Then, the first reading mode operation using the SDF is terminated (S162).

In the control procedure of FIG. 8, the amplifier gain of the analog-signal processing unit 43 which is used at the time of image reading is changed at the steps S147 and S159 between the given gain G2a for the second reading mode and the given gain G2b for the first reading mode.

In the SDF reading mode, the image reading of the document is performed with the reading optical unit at the home position. The output level of the read data signal in the SDF reading mode is usually smaller than that in the traditional reading mode under the influence of the lifting of the document and the different irradiation conditions of the illuminating lamp.

It is necessary that the shading correction processing is performed according to the above-mentioned formula (1). In order to eliminate the problem, the image reading device of the present embodiment is configured so that the amplifier gain of the analog-signal processing unit 43 at the time of image reading in the SDF reading mode is made large in comparison with that in the traditional reading mode.

Namely, it is adequate that the image reading device of the present embodiment is configured such that the condition G2a<G2b is met. According to the present embodment, it is possible to raise the brightness of the image data in the SDF reading mode after the shading correction is performed. The gain G2a of the analog-signal processing unit 43 at the time of image reading in the traditional reading mode is almost equal to the gain G1.

The ratio of the gains G2a and G2b may be preset to the initial value calculated through the experiment. Alternatively, it may be adjusted at the time of factory adjustment by reading the same document for both the traditional reading mode and the SDF reading mode and setting the ratio so that the output levels of the read data signals for the both modes may become the same.

Furthermore, the image forming apparatus in the present embodment may be configured to include an operation panel that allows the user or the service person to set the kind of the document. The image reading device of the present embodiment is provided to change the gain of the analog-signal processing unit 43 depending on the kind of the document set by the user or the service person.

Therefore, according to the fourth preferred embodiment, the difference in the output level of the read data signal between the first reading mode and the second reading mode can be minimized by changing the gain of the analog-signal processing unit at the time of image reading according to the selected one of the first reading mode and the second reading mode.

A description will be given of the fifth preferred embodiment of the present invention.

The composition and functions of the image forming apparatus and the image reading device of the fifth preferred embodument are essentially the same as those described above with reference to FIG. 1 through FIG. 4, and a duplicate description thereof will be omitted.

The shading correction processing performed by the shading correcting unit 46 is to generate shading data by reading the white reference board 11 before reading the image from the document. The shading data is stored in the memory, and the shading correction processing between the read data “D” and the shading data “Sd” at each reading position of the main scanning direction is performed per dot.

When the data of each dot has 8 bits of image information, the data after the shading correction is represented by the above equation (1): Data=D/Sd×255.

In this case, the reference top voltage Vreft to the A/D converter 44 is changed by the switching unit 63 between the voltage V1 when the shading data Sd is generated and the voltage V2 when the image reading is performed to generate the read data D. By the switching operation, the voltage V1 is outputted to the A/D converter 44 as the reference top voltage Vreft at the time of generating the shading data Sd, and the voltage V2 is outpted to the A/D converter 44 as the reference top voltage Vreft at the time of generating the read data D.

The adjustment of the reference voltage is performed for the scanner 40 at the time of factory adjustment such that the criteria chart sheet is read and the reference top voltage Vreft-V2 at the time of the image reading is adjusted to the desired value for a certain reflection factor.

The adjustment of the reference voltage for the scanner 40 is performed for every model to eliminate the variations of the respective models in the optical reading level. The reference voltages V1 and V2 are set up in the DA converter 62 by the control unit 61 at the time of initialization, and the reference voltages are supplied to the switching unit 63.

Apart from the forgoing embodiments, in the fifth preferred embodiment, the multiplication of a correction factor K to the shading data represented by the above equation (1) is carried out.

Namely, when the data of each dot has 8 bits of image information, the data after the shading correction in the present embodiment is representated by the following equation: Data=D/Sd×255×K (2).

In addition, in the present embodiment, this correction factor K is changed selectively betweem at the time of the first reading mode (or the SDF reading mode) and at the time of the second reading mode (or the traditional reading mode).

In the SDF reading mode, the image reading is carried out with the scanner unit fixed at the home position. The readout level in the SDF reading mode is usually lower than that in the traditional reading mode because of the influence of the lifting of the document and the different irradiation conditions of the illuminating lamp. Namely, the brightness of the reproduced image becomes dark.

For example, supposing that the readout level at the time of the traditional reading mode is 100%, there is a case in which the readout level at the time of the SDF reading mode becomes 90%. In such a case, the readout level after the shading correction at the time of the SDF reading mode can be made equivalent to that of the tranditional reading mode by changing the correction factor K selectively between K=1.1 at the time of the SDF reading mdoe and K=1.0 at the time of the traditional reading mode.

The adjustment of the shading data correction factor K may be preset to the initial value calculated through the experiment. Alternatively, it may be adjusted at the time of factory adjustment by reading the same document for both the traditional reading mode and the SDF reading mode and setting the ratio of the two correction factors so that the readout levels for the both modes may become the same. Or the image forming apparatus in the present embodiment may be configured to include an operation panel that allows the user or the service person to adjust the ratio of the two correction factors.

In the case of a color image reading device, the shading correction operation is performed for each of R, G and B signals. When the ratio of the readout levels of the SDF reading data and the traditional reading data differs between R, G and B signals, it is possible that the image reading device of the present embodiment has different ratios of the two shading correction factors for the respective RGB signals.

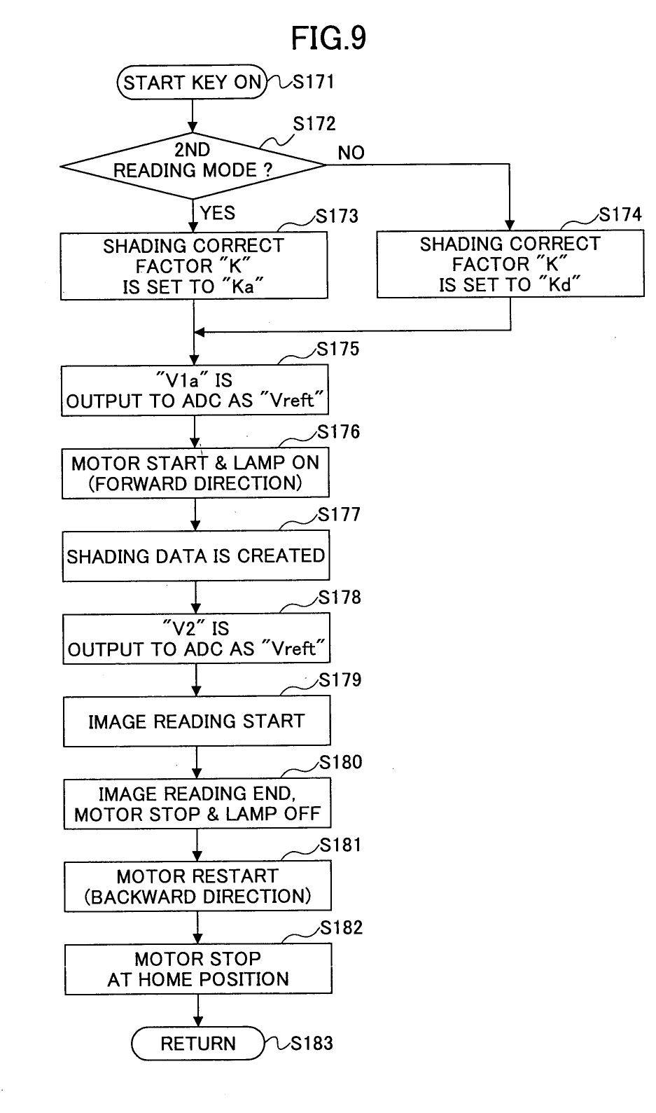

FIG. 9 is a flowchart for explaining a control procedure of the fifth preferred embodiment of the present invention. In the control procedure, the output level of the read data signal after the shading correction is performed is made equivalent for both the SDF reading mode and the tranditional reading mode.

The control procedure of FIG. 9 is started by the system controller (not shown) when the start key of the image forming apparatus is set in ON state in order to perform the copier function (S171).

The system controller determines whether the document is set on the contact glass 1 to perform the image reading, or it determines whether the second reading mode is selected (S172).

When the result of the determination at step S172 is affirmative (the second reading mode), the system controller sets the shading correction factor K to a given value Ka for the second reading mode (S173). For example, it is set to Ka=1.0 when the shading correction is performed based on the second reading mode (the traditional reading mode).

On the other hand, when the result of the determination at step S172 is negative, the first reading mode operation is started to perform the image reading of the document using the SDF 20. The system controller in this case sets the shading correction factor K to a given value Kd for the SDF reading mode (S174). The control procedure after the step S174 is performed is essentially the same as that in the previously described embodiments, and a description thereof will be omitted.

When the step S173 (or the step S174) is performed, the system controller selects the output voltage V1 of the DAC 62, sets the output voltage V1 to the reference voltage V1a, and causes the switching unit 63 to output the reference voltage V1a to the A/D converter 44 as the reference top voltage Vreft (S175).

After the step S175 is performed, the system controller starts the carriage motor and sets the illuminating lamp 2 in ON state so that the first carriage 6 and the second carriage 7 are moved in the forward direction (S176).

When the first carriage 6 reaches the white reference board 11, the system controller causes the shading corrector 46 to generate the shading data Sd by scanning the white reference board 11 (S177).

After the shading data is created, the system controller causes the switching unit 63 to output the reference voltage V2 to the A/D converter 44 as the reference top voltage Vreft (S178).

When the first carriage 6 reaches the front-end edge of the document on the contact glass 1, the system controller starts the image reading of the document (S179).

When the first carriage 6 reaches the rear-end edge of the document, the system controller terminates the image reading of the document by stopping the carriage motor and setting the illuminating lamp 2 in OFF state (S180).

After the step S180 is performed, the system controller causes the first carriage 6 and the second carriage 7 to be moved in the backward direction (S181).

When the first carriage 6 and the second carriage 7 arrive at the home position, the system controller stops the carriage motor (S182). Then, the image reading operation is terminated (S183).

Other elements in the present embodiment are essentially the same as those corresponding elements in the first preferred embodiment described above, unless otherwise specified.

According to the fifth preferred embodiment, the difference in the output level of the read data signal between the first reading mode and the second reading mode can be minimized such that both the output levels are equivalent to each other, by changing the shading correction factor K selectively.

A description will be given of the sixth preferred embodiment of the present invention.

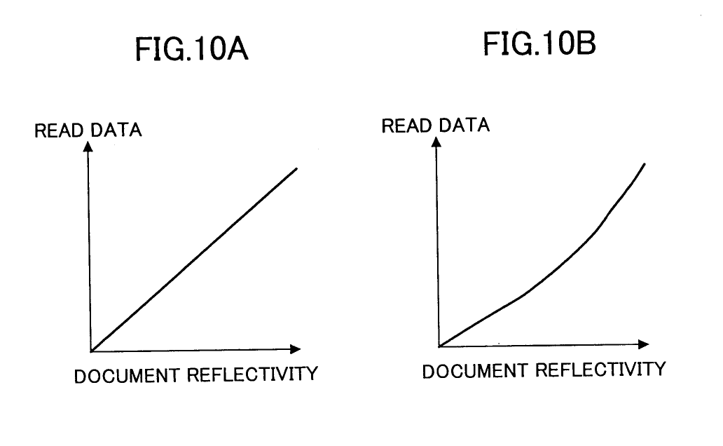

FIG. 10A and FIG. 10B show the relationship between the document reflectivity and the read data signal level.

Although the control procedure of FIG. 9 is adequate for eliminating the problems of the present invention when the signal level-to-reflectivity relationship is linear as shown in FIG. 10A, it is inadequate when the relationship is non-linear as shown in FIG. 10B. In the latter case, an error of the output level of the read data signal when the control procedure of FIG. 9 is performed becomes large because of the non-linearity of the signal level-to-reflectivity relationship.

As described previously, in the scanner gamma unit 49, the data which has linear characteristics with respect to the reflectivity is transformed into data having characteristics that improve the precision of the color correction performed by the subsequent color corrector 52. In the present embodiment, the above-mentioned error in the non-linear case can be reduced by changing gamma data of the scanner gamma unit 49 at the time of the SDF reading mode so as to correct the non-linear characteristics as shown in FIG. 10B.

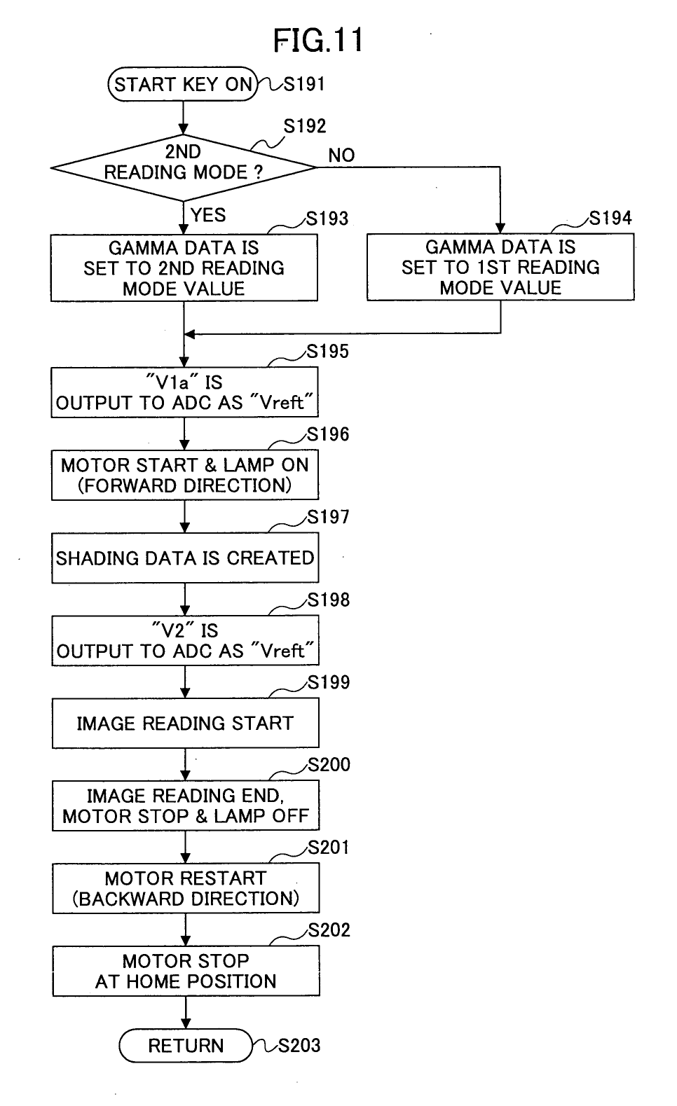

FIG. 11 is a flowchart for explaining a control procedure of the sixth preferred embodiment of the present invention. This control procedure is effective when the relationship between the document reflectivity and the read data signal level at the time of the SDF reading mode is non-linear as shown in FIG. 10B. In the control procedure, the gamma data of the scanner gamma unit 49 is changed selectively between the first reading mode and the second reading mode, and the output level of the read data signal after the gamma correction is performed is made equivalent for both the SDF reading mode and the tranditional reading mode.

The control procedure of FIG. 11 is started by the system controller (not shown) when the start key of the image forming apparatus is set in ON state in order to perform the copier function (S191).

The system controller determines whether the document is set on the contact glass 1 in order to perform the image reading, or it determines whether the second reading mode is selected (S192).

When the result of the determination at step S192 is affirmative (the second reading mode), the system controller sets the gamma data of the scanner gamma unit 49 to a given gamma data for the second reading mode (S193).

On the other hand, when the result of the determination at step S192 is negative, the first reading mode operation is started to perform the image reading of the document using the SDF 20. The system controller in this case sets the gamma data of the scanner gamma unit 49 to a given gamma data for the first reading mode (S194). The control procedure after the step S194 is performed is essentially the same as that in the previously described embodiments, and a description thereof will be omitted.

When the step S193 (or the step S194) is performed, the system controller selects the output voltage V1 of the DAC 62, sets the output voltage V1 to the reference voltage V1a, and causes the switching unit 63 to output the reference voltage V1a to the A/D converter 44 as the reference top voltage Vreft (S195).

After the step S195 is performed, the system controller starts the carriage motor and sets the illuminating lamp 2 in ON state so that the first carriage 6 and the second carriage 7 are moved in the forward direction (S196).

When the first carriage 6 reaches the white reference board 11, the system controller causes the shading corrector 46 to generate the shading data Sd by scanning the white reference board 11 (S197).

After the shading data is created, the system controller causes the switching unit 63 to output the reference voltage V2 to the A/D converter 44 as the reference top voltage Vreft (S198).

When the first carriage 6 reaches the front-end edge of the document on the contact glass 1, the system controller starts the image reading of the document (S199).

When the first carriage 6 reaches the rear-end edge of the document, the system controller terminates the image reading of the document by stopping the carriage motor and setting the illuminating lamp 2 in OFF state (S200).

After the step S200 is performed, the system controller causes the first carriage 6 and the second carriage 7 to be moved in the backward direction (S201).

When the first carriage 6 and the second carriage 7 arrive at the home position, the system controller stops the carriage motor (S202). Then, the image reading operation is terminated (S203).

Other elements in the present embodiment are essentially the same as those corresponding elements in the first preferred embodiment described above, unless otherwise specified.

According to the sixth preferred embodiment, the difference in the output level of the read data signal between the first reading mode and the second reading mode can be minimized such that both the output levels are equivalent to each other, by changing the gamma data of the scanner gamma unit 49 selectively.

Moreover, even when the difference in the output level of the read data signal between the first reading mode and the second reading mode is varied depending on the optical density of the document, the problems of the present invention can be eliminated by changing the gamma data of the scanner gamma unit 49 suitably.

Furthermore, the document thickness varies depending the kind of the document, e.g., thin-sheet paper or thick-sheet paer. In the image reading device equipped with the SDF 20, as shown in FIG. 2, the document is warped through the transport thereof in the transport path. The document rigidity and the warping action change with the difference in thickness of the document. For example, there is a case in which the ratio of the readout level of the first reading mode to the second reading mode for a thin-sheet document is 90% and the ratio of the readout level of the first reading mode to the second reading mode for a thick-sheet document is 85%.

In order to eliminate the problem, the image forming apparatus of the present invention may be configured to include an operation panel that allows the user or the service person to set the kind of the document. The image reading device of the fifth or sixth preferred embodiment is provided to change the shading correction factor or the scanner gamma data depending on the kind of the document set by the user or the service person.

Consequently, it is possible for the present invention to optimize the output level of the read data signal when the document is optically read, irrespective of whether the document is read in the SDF reading mode or the traditional reading mode. Moreover, according to the present invention, the difference in the readout level between the SDF reading mode and the traditional reading mode is made as small as possible by the image reading device, and the quality of image formation can be stabilized based on the kind of the document being read.

In addition, the optical reading unit in the claims corresponds to the illuminating lamp 2, the mirrors 3, 4 and 5, the first carriage 6, the second carriage 7 and the lens unit 8 in the above-described embodiments. The photoelectric-conversion unit in the claims corresponds to the CCD 9 in the above-described embodiments. The analog-to-digital conversion unit in the claims corresponds to the A/D converter 44 in the above-described embodiments. The analog-signal processing unit in the claims corresponds to the analog-signal processing unit 43 in the above-described embodiments. The correction unit in the claims corresponds to the image-processor unit 41, including the control unit 61, the D/A converter 62, the switching unit 63 and the A/D converter 44, or the system controller in the above-described embodiments.

The present invention is not limited to the above-described embodiments, and variations and modifications may be made without departing from the scope of the present invention.

Further, the present invention is based on Japanese priority application No. 2002-260232, filed on Sep. 5, 2002, the entire contents of which are hereby incorporated by reference.

What is claimed is

1. An image reading device having a first reading mode and a second reading mode in which the first reading mode is performed with a reading optical unit being fixed to read a document being transported and the second reading mode is performed with the reading optical unit being moved to read a document fixed to the image reading device, the image reading device comprising:
a photoelectric conversion unit converting image data, optically read from a document, into an analog signal;
the reading optical unit irradiating light to the document and directing a reflected light from the document to the photoelectric conversion unit;
an analog-signal processing unit sampling the analog signal outputted by the photoelectric conversion unit, and performing gain adjustment of the sampled analog signal in response to a control signal;
an analog-to-digital conversion unit converting the analog signal, outputted by the analog-signal processing unit, based on a reference voltage so that the analog-to-digital conversion unit outputs a digital signal of the read data at an output level; and
a correction unit optimizing the output level of the read data signal for each of the first reading mode and the second reading mode by changing either the control signal outputted to the analog-signal processing unit or the reference voltage outputted to the analog-to-digital conversion unit.

2. The image reading device according to claim 1 wherein the correction unit is provided to change a dynamic range of the analog-to-digital conversion unit at a time of shading data generating, with respect to each of the first reading mode and the second reading mode.

3. The image reading device according to claim 1 wherein the correction unit is provided to change a dynamic range of the analog-to-digital conversion unit at a time of image reading, with respect to each of the first reading mode and the second reading mode.

4. The image reading device according to claim 1 wherein the correction unit is provided to change a gain of the analog-signal processing unit at a time of shading data generating, with respect to each of the first reading mode and the second reading mode.

5. The image reading device according to claim 1 wherein the correction unit is provided to change a gain of the analog-signal processing unit at a time of image reading, with respect to each of the first reading mode and the second reading mode.

6. An image reading device having a first reading mode and a second reading mode in which the first reading mode is performed with a reading optical unit being fixed to read a document being transported and the second reading mode is performed with the reading optical unit being moved to read a document fixed to the image reading device, the image reading device comprising:
a photoelectric conversion unit converting image data, optically read from a document, into an analog signal;
the reading optical unit irradiating light to the document and directing a reflected light from the document to the photoelectric conversion unit;
an analog-signal processing unit sampling the analog signal outputted by the photoelectric conversion unit, and performing gain adjustment of the sampled analog signal in response to a control signal;
an analog-to-digital conversion unit converting the analog signal, outputted by the analog-signal processing unit, based on a reference voltage so that the analog-to-digital conversion unit outputs a digital signal of the read data at an output level; and
a correction unit optimizing the output level of the read data signal for each of the first reading mode and the second reading mode so that the output level of the read data signal for the first reading mode and the output level of the read data signal for the second reading mode are equivalent to each other.

7. The image reading device according to claim 6 wherein the correction unit is provided to change a correction factor of shading data with respect to each of the first reading mode and the second reading mode.

8. The image reading device according to claim 6 wherein the correction unit is provided to change a gamma data of a scanner gamma unit with respect to each of the first reading mode and the second reading mode.

9. The image reading device according to claim 6 further comprising an operation unit which allows a user to set a kind of the document when the document is read in the first reading mode, wherein the correction unit is provided to optimize the output level of the read data signal based on the document kind set by the user.

10. The image reading device according to claim 1 or claim 6 wherein the correction unit comprises a switching unit which selects one of a first reference voltage and a second reference voltage that is outputted to the analog-to-digital conversion unit.

11. An image forming apparatus comprising:
an image reading device; and
an image formation unit forming a visible image on an image recording medium based on an image data signal outputted by the image reading device,
the image reading device having a first reading mode and a second reading mode in which the first reading mode is performed with a reading optical unit being fixed to read a document being transported and the second reading mode is performed with the reading optical unit being moved to read a document fixed to the image reading device, the image reading device comprising:
a photoelectric conversion unit converting image data, optically read from a document, into an analog signal;
the reading optical unit irradiating light to the document and directing a reflected light from the document to the photoelectric conversion unit;
an analog-signal processing unit sampling the analog signal outputted by the photoelectric conversion unit, and performing gain adjustment of the sampled analog signal in response to a control signal;
an analog-to-digital conversion unit converting the analog signal, outputted by the analog-signal processing unit, based on a reference voltage so that the analog-to-digital conversion unit outputs a digital signal of the read data at an output level; and
a correction unit optimizing the output level of the read data signal for each of the first reading mode and the second reading mode by changing either the control signal outputted to the analog-signal processing unit or the reference voltage outputted to the analog-to-digital conversion unit.

12. An image reading device having a first reading mode and a second reading mode in which the first reading mode is performed with a reading optical unit being fixed to read a document being transported and the second reading mode is performed with the reading optical unit being moved to read a document fixed to the image reading device, the image reading device comprising:
photoelectric conversion means for converting image data, optically read from a document, into an analog signal;
reading optical means for irradiating light to the document and for directing a reflected light from the document to the photoelectric conversion means;
analog-signal processing means for sampling the analog signal outputted by the photoelectric conversion means, and for performing gain adjustment of the sampled analog signal in response to a control signal;
analog-to-digital conversion means for converting the analog signal, outputted by the analog-signal processing means, based on a reference voltage so that the analog-to-digital conversion means outputs a digital signal of the read data at an output level; and
correction means for optimizing the output level of the read data signal for each of the first reading mode and the second reading mode by changing either the control signal outputted to the analog-signal processing means or the reference voltage outputted to the analog-to-digital conversion means.

13. The image reading device according to claim 12 wherein the correction means is provided to change a dynamic range of the analog-to-digital conversion means at a time of shading data generating, with respect to each of the first reading mode and the second reading mode.

14. The image reading device according to claim 12 wherein the correction means is provided to change a dynamic range of the analog-to-digital conversion means at a time of image reading, with respect to each of the first reading mode and the second reading mode.

15. The image reading device according to claim 12 wherein the correction means is provided to change a gain of the analog-signal processing means at a time of shading data generating, with respect to each of the first reading mode and the second reading mode.

16. The image reading device according to claim 12 wherein the correction means is provided to change a gain of the analog-signal processing means at a time of image reading, with respect to each of the first reading mode and the second reading mode.

17. An image reading device having a first reading mode and a second reading mode in which the first reading mode is performed with a reading optical unit being fixed to read a document being transported and the second reading mode is performed with the reading optical unit being moved to read a document fixed to the image reading device, the image reading device comprising:
photoelectric conversion means converting image data, optically read from a document, into an analog signal;
reading optical means for irradiating light to the document and for directing a reflected light from the document to the photoelectric conversion means;
analog-signal processing means for sampling the analog signal outputted by the photoelectric conversion means, and for performing gain adjustment of the sampled analog signal in response to a control signal;
analog-to-digital conversion means for converting the analog signal, outputted by the analog-signal processing means, based on a reference voltage so that the analog-to-digital conversion means outputs a digital signal of the read data at an output level; and
correction means for optimizing the output level of the read data signal for each of the first reading mode and the second reading mode so that the output level of the read data signal for the first reading mode and the output level of the read data signal for the second reading mode are equivalent to each other.

18. The image reading device according to claim 17 wherein the correction means is provided to change a correction factor of shading data with respect to each of the first reading mode and the second reading mode.

19. The image reading device according to claim 17 wherein the correction means is provided to change a gamma data of a scanner gamma unit with respect to each of the first reading mode and the second reading mode.

20. The image reading device according to claim 17 further comprising operation means for allowing a user to set a kind of the document when the document is read in the first reading mode, wherein the correction means is provided to optimize the output level of the read data signal based on the document kind set by the user.

21. The image reading device according to claim 12 or claim 17 wherein the correction means comprises switching means for selecting one of a first reference voltage and a second reference voltage that is outputted to the analog-to-digital conversion means.

22. An image forming apparatus comprising:
an image reading device; and
an image formation unit forming a visible image on an image recording medium based on an image data signal outputted by the image reading device,
the image reading device having a first reading mode and a second reading mode in which the first reading mode is performed with a reading optical unit beng fixed to read a document being transported and the second reading mode is performed with the reading optical unit being moved to read a document fixed to the image reading device, the image reading device comprising:
photoelectric conversion means for converting image data, optically read from a document, into an analog signal;
reading optical means for irradiating light to the document and for directing a reflected light from the document to the photoelectric conversion means;
analog-signal processing means for sampling the analog signal outputted by the photoelectric conversion means, and for performing gain adjustment of the sampled analog signal in response to a control signal;
analog-to-digital conversion means for converting the analog signal, outputted by the analog-signal processing means, based on a reference voltage so that the analog-to-digital conversion means outputs a digital signal of the read data at an output level; and
correction means for optimizing the output level of the read data signal for each of the first reading mode and the second reading mode by changing either the control signal outputted to the analog-signal processing means or the reference voltage outputted to the analog-to-digital conversion means.
